(19) United States
(12) Patent Application Publication
(10) Pub. No.: US 2008/0137010 A1
(43) Pub. Date: Jun. 12, 2008

(54) POLARIZING ELEMENT, METHOD FOR MANUFACTURING THE SAME, LIQUID CRYSTAL DEVICE AND ELECTRONIC APPARATUS

(75) Inventor: Yoshitomo KUMAI, Okaya-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/950,535

(22) Filed: Dec. 5, 2007

(30) Foreign Application Priority Data
Dec. 7, 2006 (JP) 2006-330449

(51) Int. Cl. G02F 1/1335; G02B 5/30; B44C 1/22

(52) U.S. Cl. 349/96; 359/485; 216/24

(57) ABSTRACT

A polarizing element includes a polarizing element member formed on a substrate and composed of a metal film that has a slit-shaped opening, the opening being provided in a plural number, a coating film formed on the polarizing element member and a space surrounded by the coating film, the substrate and the metal film.

### BACKGROUND OF THE INVENTION

1. Technical Field

The present invention relates to a polarizing element, a method for manufacturing the same, a liquid crystal device and an electronic apparatus.

2. Related Art

A polarizing element is used in a light valve for a liquid crystal projector. In order to prevent deterioration under a high-temperature state and to increase light resistance of the polarizing element, Japanese Patent No. 3,654,553 (a first example) proposes a polarizing element having a grid pattern which is made of an organic material such as aluminum and formed on a glass substrate. JP-A-2002-520677 (a second example) proposes that such polarizing element be fitted in a liquid crystal device.

According to the first example, a protection film and an insulating film are needed to be formed on the polarizing element in a case where the polarizing element made of an organic material is used as one of function elements forming the liquid crystal device. Especially where the polarizing element is formed on the inner face side (liquid crystal side) of the substrate in the liquid crystal device as disclosed in the second example, the insulating film and an electrode are formed over the polarizing element so that a protection film covering the polarizing element becomes essential. However, if the protection film such as a silicon oxide film is formed directly on the polarizing element having the grid pattern made of an organic material, the optical characteristics of the polarizing element are largely deteriorated.

### SUMMARY

An advantage of the present invention is to provide a polarizing element having a coating film on the surface and fine optical characteristics, and to provide a manufacturing method thereof.

A polarizing element according to a first aspect of the invention includes a polarizing element member formed on a substrate and composed of a metal film that has a slit-shaped opening, the opening is provided in a plural number, a coating film formed on the polarizing element member and a space surrounded by the coating film, the substrate and the metal film. In this way, the polarizing element can have the same optical characteristics as those of a polarizing element in which the metal film forming the polarizing element member is released in the air.

A polarizing element according to a second aspect of the invention includes a polarizing element member formed on a substrate and composed of a metal film that has a slit-shaped opening, the opening is provided in a plural number, a coating film formed on the polarizing element member and an air layer formed in the opening. According to the second aspect, it is possible to realize the polarizing element having fine optical characteristics because the air layer is provided inside the opening. Alternatively, the opening can be filled with a predetermined gas (an argon gas, a nitrogen gas or the like) or the opening can be retained in vacuum state.

In these cases, it is preferable that an open end of the opening be closed by a part of the coating film which is an aggregation of crystal grains that grow from an upper face of the metal film toward a direction opposite to the metal film. In this way, the open end of the opening can be easily closed through the formation process of the coating film. Consequently, it is possible to simplify the manufacturing process of the polarizing element.

It is also preferable that a seed layer containing a constituent element of the coating film be formed on an upper face of the metal film, and the coating film be an aggregation of crystal grains that grow from the seed layer. By providing the seed layer that controls the crystal grains of the coating film, it is possible to control the growth of the crystal grains at ease. Accordingly, the open end of the opening can be efficiently blocked out at the time when the coating film is formed.

It is also preferable that the seed layer be selectively formed only on the upper face of the metal film. In this way, it is possible to prevent a part of the coating film from being formed on the side face of the metal film. Consequently, the coating film is hardly formed inside the opening in the polarizing element. This means that such polarizing element can acquire fine optical characteristics.

It is preferable that the seed layer and the coating film be made of silicon oxide. In this way, the polarizing element has a fine fabrication yield, and fine light transmissivity and insulation property of the coating film. In a case where a conductive film is formed on the coating film, it is possible to prevent the short circuit between the conductive film and the metal film of the polarizing element member.

A method for manufacturing a polarizing element according to a third aspect of the invention includes a) forming a metal film on a substrate, b) forming a seed layer on the metal film, c) forming an etching mask on the seed layer by patterning, d) forming a slit-shaped opening in the metal film by removing the seed layer and the metal film partially through an etching process that uses the etching mask and f) forming a coating film that contains a constituent element of the seed layer on the metal film and the seed layer after the etching process.

In this case, it is preferable that the etching process be dry-etching, and the seed layer and the metal film that are exposed in an opening area of the etching mask be simultaneously removed through the etching process. In this way, the manufacturing efficiency can be improved and the polarizing element can be manufactured at a lower cost.

It is also preferable that crystal grains be grown on the metal film from the seed layer in the step f) and the crystal grains close the slit-shaped opening. In this way, the polarizing element having the hollow space in the opening of the metal film can be easily fabricated only by forming the coating film.

It is also preferable that silicon oxide films be formed as the seed layer and the coating film. In this way, it is possible to easily fabricate the polarizing element that has a fine protection of the polarizing element member, a fine light transmissivity of the coating film, and a fine insulating property of the polarizing element member.

A liquid crystal device according to a fourth aspect of the invention includes the above-described polarizing element. In this way, it is possible to provide a liquid crystal device that has fine optical characteristics and the reliable polarizing element in which the polarizing element member is protected.

In this case, it is preferable that a liquid crystal layer be provided between a pair of substrates, the polarizing element be formed on a face of at least one of the pair of the substrates and the face is on a side of the liquid crystal layer. In this way, it is possible to provide the liquid crystal device in which a reflective polarizing layer is embedded.

It is also preferable that the liquid crystal device be a transflective type liquid crystal device in which both a transmissive display and a reflective display are possible in a single pixel, and wherein the polarizing element be provided as a reflective layer for the reflective display. In this way, it is possible to provide the transflective type liquid crystal device having a fine contrast both in the transmissive display and the reflective display.

An electronic apparatus according to a fifth aspect of the invention includes the above-described liquid crystal device. In this way, it is possible to provide the electronic apparatus that has a display part or an optical modulation device having a fine display quality and reliability. An electronic apparatus according to a sixth aspect of the invention includes the above-described polarizing element. In this way, it is possible to provide the electronic apparatus that has a polarizing optical system having fine optical characteristics and reliability.

### BRIEF DESCRIPTION OF THE DRAWINGS

The invention will be described with reference to the accompanying drawings, wherein like numbers reference like elements.

FIGS. 1A and 1B are a partial sectional view and a perspective view of a polarizing element according to a first embodiment of the invention.

FIG. 2 is an explanatory drawing showing operation of the polarizing element.

FIGS. 3A-3C are schematic configurations and graphs showing optical characteristic differences according to different configurations.

FIGS. 4A through 4E are sectional views of the polarizing element according to the first embodiment showing its manufacturing steps.

FIG. 5 is a schematic block diagram of an exposure apparatus used in the manufacturing process of the polarizing element.

FIG. 6A is a picture of the polarizing element according to the first embodiment showing its sectional structure and FIG. 6B is a picture of a typically known polarizing element showing its structure.

FIG. 7 is an equivalent circuit schematic of a liquid crystal device according to a second embodiment.

FIG. 8 is a planer view of a pixel region in the liquid crystal device according to the second embodiment.

FIG. 9 is a sectional view of the liquid crystal device along the line A-A′ in FIG. 8.

FIG. 10 is a plan view of a sub-pixel region in a liquid crystal device according to a third embodiment.

FIG. 11 is a sectional view of the liquid crystal device along the line B-B′ in FIG. 10.

FIG. 12 is a plan view of a sub-pixel region in a liquid crystal device according to a fourth embodiment.

FIG. 13A is a partial sectional view of the liquid crystal device along the line D-D′ in FIG. 12 and FIG. 13B is a partial sectional view of the liquid crystal device along the line F-F′ in FIG. 12.

FIG. 14 is a schematic configuration diagram of a projector according to a fifth embodiment.

FIG. 15 is a perspective view of an example of an electronic apparatus.

### DESCRIPTION OF EXEMPLARY EMBODIMENTS

Embodiments of the invention will be described. Examples of the polarizing element and the manufacturing method thereof are described with to the accompanying drawings. A scale size is appropriately set by each of the accompanying drawings in order to make members or components recognizable.

### First Embodiment

Polarizing Element

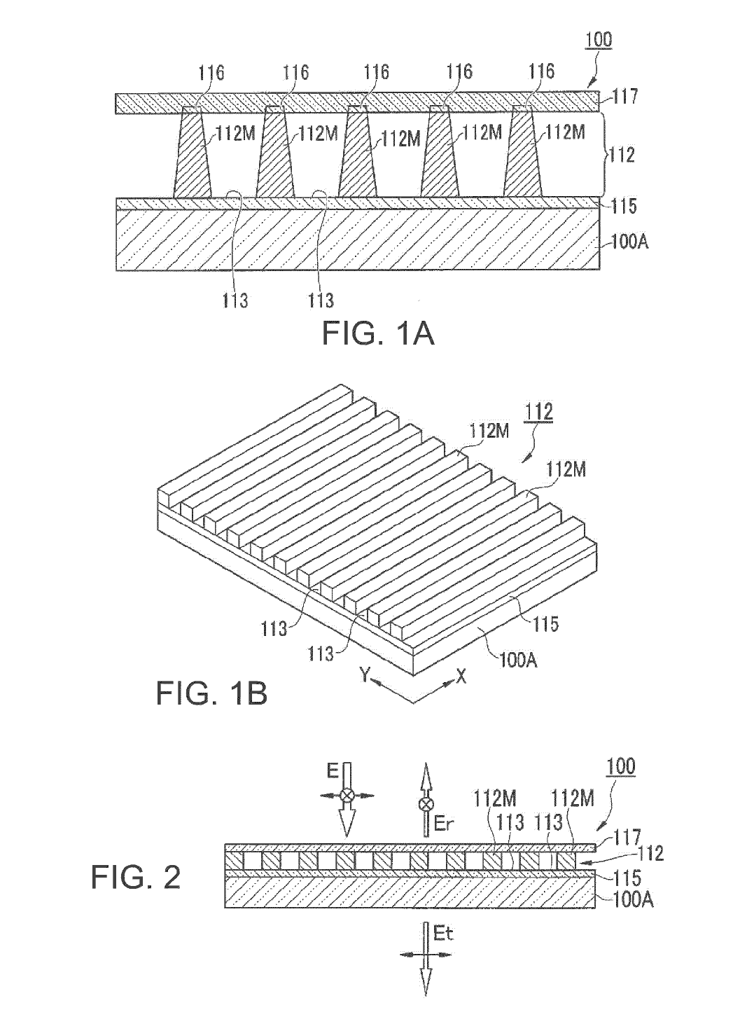

FIG. 1A is a partial sectional view of a polarizing element 100. FIG. 1B is a perspective view of a polarizing element member 112 forming the polarizing element 100. FIG. 2 is an explanatory drawing showing operation of the polarizing element 100.

The polarizing element 100 is a light-reflective type polarizing element. The polarizing element 100 has a base layer 115 covering a base substrate 100A, the polarizing element member 112 formed on the base layer 115, and a coating film 117 formed on the polarizing element member 112. The polarizing element member 112 is mainly formed of a metal film 112M that is provided on the surface of the base layer 115 and has a slit-shaped opening 113 which is provided in the plural number. The polarizing element member 112 has a wire grid structure. The metal film 112M is patterned in a striped form when it is viewed in a planar direction. The strip has for example a width of 70 nm, a height of 100 nm and a pitch of 140 nm. A seed layer 116 is formed on the upper face (ceiling) of the metal film 112M. The coating film 117 is a transparent thin film which is made by the crystal growth of the seed layer 116.

The base substrate 100A is a transparent substrate made of glass, quartz, plastic or the like. In a case of a reflective-type polarizing element, an opaque substrate such as a metal substrate and a ceramic substrate can be used as the base substrate 100A.

The base layer 115 is formed on the surface of the base substrate 100A if needed. The base layer 115 can be formed from for example a silicon oxide film or an aluminum oxide film. The base layer 115 prevents the base substrate from being damaged from an etching gas and the like which is used in an etching process for patterning the metal film 112M. The base layer 115 also enhances the adhesion of the metal film 112M. In case where the reflective-type polarizing element is formed as the polarizing element 100, the base layer 115 can be made form a metal material having an optical reflection property.

A metal material forming the metal film 112M includes silver, gold, copper, palladium, platinum, rhodium, silicon, nickel, cobalt, manganese, iron, chromium, titanium, ruthenium, niobium, neodymium, ytterbium, yttrium, molybdenum, indium and bismuth in addition to aluminum, and alloys thereof. A transparent dielectric film may be formed on the surface of the metal film 112M. In a case where the metal film 112M is made of aluminum, for example, the surface of the metal film 112M can be oxidized through a heat treatment and the dielectric film made of aluminum oxide can be formed.

The seed layer 116 in this embodiment is made of a transparent material containing the same component as that of the coating film 117. More specifically, these films are made of a transparent insulating material such as silicon oxide. In addition to transparent insulating materials, a transparent conductive material such as indium tin oxide (ITO) can also be used to form the films.

Referring to FIG. 2, the polarizing element 100 has the stripe pattern that has a pitch which is smaller than the optical wavelength. Thereby it is possible to conduct polarization selection depending on a polarization direction of a light beam entered into the polarizing element 100. More specifically, a linearly-polarized light beam Et having the polarizing axis orthogonal to the direction in which the metal film 112M extends penetrates the polarizing element 100. Whereas a linearly-polarized light beam Er having the polarizing axis parallel to the direction in which the metal film 112M extends is reflected by the polarizing element 100. In other words, the polarizing element 100 in this embodiment has a reflection axis that lies parallel to the direction (the X-axis direction in FIG. 1B) in which the metal film 112M extends and has a transmission axis that lies orthogonal to the reflection axis (in the Y-axis direction FIG. 1B).

Referring to FIG. 1A, in the polarizing element 100 of this embodiment, the opening 113 surrounded by the metal film 112M, the coating film 117 and the base layer 115 is a hollow space. The inside of the opening 113 is the air (or other gas) layer or in vacuum state. By providing the opening 113 which is the hollow space, the optical characteristics (polarization selectivity) is not deteriorated even if a functional element and the like are formed over the coating film 117.

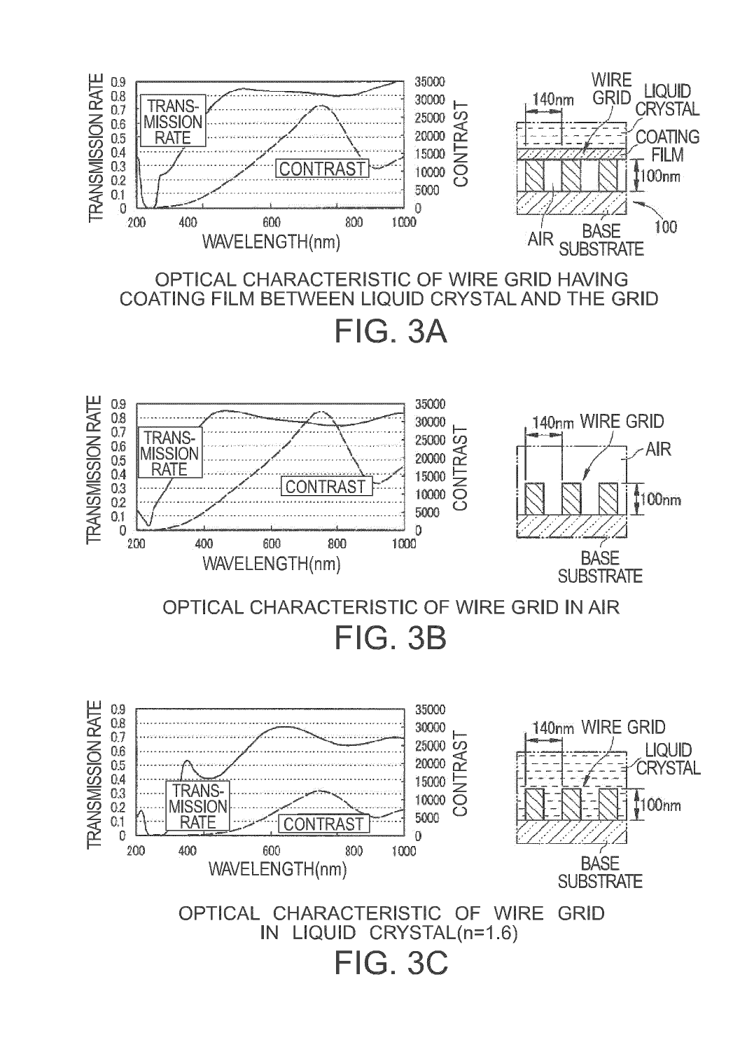

FIG. 3A shows a schematic configuration of the polarizing element 100 of the embodiment that is provided in the liquid crystal and shows a graph of its optical characteristics (transmittancetransmittance and contrast). FIG. 3B shows a schematic configuration of a wire grid polarizing element (which corresponds to the polarizing element member 112) that is released in the air and shows a graph of its optical characteristics. FIG. 3C shows a schematic configuration of the polarizing element shown in FIG. 3B that is provided in the liquid crystal and shows a graph of its optical characteristics.

Referring to FIG. 3C, the polarizing element 100 according to the embodiment has the coating film 117 that covers the polarizing element member 112 including the metal film 112M. Thereby even when the polarizing element 100 which is provided in the liquid crystal, the air layer (or the vacuum state) in the opening 113 in the metal film 112M is retained. Whereas the case shown in FIG. 3C, the polarizing element does not have the coating film and the end part of the metal film in the thickness direction is released. Therefore, the openings in the metal film are filled with the liquid crystal.

If a resin film, conductive film or the like covering the metal film is formed in the wire grid type polarizing element as shown in FIG. 3C, the openings in the metal film are filled with the resin film or the conductive film even when the polarizing element is placed in the liquid crystal.

The graphs shown in FIGS. 3A-3C shows measurement results of the transmittancetransmittance (Tp) and the contrast (Tp/Ts). The transmittancetransmittance (Tp) was measured in such a way that let a linearly-polarized light beam whose vibration direction is orthogonal to the direction in which the metal film of each polarizing element extends (in other words, the linearly-polarized light beam vibrating in the direction parallel to the transmission axis of the polarizing element) go through each polarizing element. The contrast is obtained as the ratio of the transmittancetransmittance (Tp) of the linearly-polarized light beam vibrating in the direction parallel to the transmission axis of the polarizing element to the transmittancetransmittance (Ts) of the linearly-polarized light beam vibrating in the direction parallel to the reflection axis of the polarizing element.

It can be known through the graph of FIG. 3C that the polarizing element 100 of the embodiment has the equal or larger transmittancetransmittance than that of the wire grid polarizing element shown in FIG. 3B whose metal film is released in the air, even though the polarizing element 100 of the embodiment is provided in the liquid crystal. The polarizing element 100 of the embodiment also has a fine contrast (the polarization selectivity) which is comparable to the contrast of the wire grid polarizing element shown in FIG. 3B. Whereas the polarizing element shown in FIG. 3C in which the openings in the metal film are filled with the liquid crystal has a poor contrast such that the uniformity of the transmittancetransmittance in the optical wavelength is significantly deteriorated.

Though the liquid crystal is provided in the openings of the metal film of the polarizing element shown in FIG. 3C, filling any material whose refraction index differs from the refraction index of the air (for example a resin material forming a planarization film) into the openings deteriorates the optical characteristics in the same way as the case of FIG. 3C.

As described above, the polarizing element 100 according to the embodiment has the coating film 117 covering the polarizing element member 112 so that the inside of the opening 113 in the metal film 112M can be made as the hollow space. Thereby the optical characteristics of the polarizing element of the embodiment are same as those of the polarizing element whose polarizing element member is released in the air. Accordingly, it can be appropriately used as the reflective polarizing layer which is embedded in the inner face side (the liquid crystal side) of the substrate in the liquid crystal device.

In addition, the polarizing element 100 according to the embodiment has the coating film 117 forming over the polarizing element member 112 so that it is possible to protect the fine stripe-shaped metal film 112. Therefore, the polarizing element according to the embodiment can exert a greater reliability even when the element is used independently as a polarizing plate.

Moreover, according to the embodiment, it is possible to maintain the inside of the opening 113 as the hollow space with the coating film 117 even if other functional elements are formed by forming the insulating layers or the conductive films on the polarizing element 100. Consequently, the polarizing element can be used as a functional component of an electronic apparatus and the like without impairing the optical characteristics of the polarizing element 100. Furthermore, the upper face of the polarizing element 100 is planarized by the coating film 117 according to the embodiment thereby it is possible to perform the fabrication of functional elements on the coating film 117 easily and precisely. Consequently, it is possible to improve the functionality and the fabrication yield of the equipment having the polarizing element 100.

Method For Manufacturing Polarizing Element

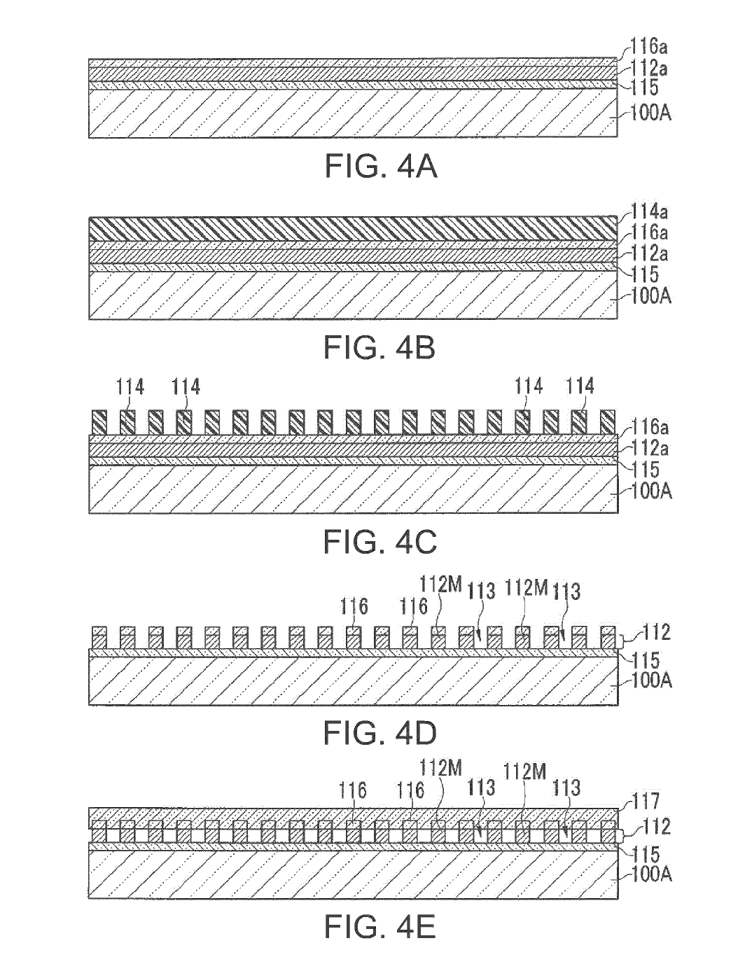

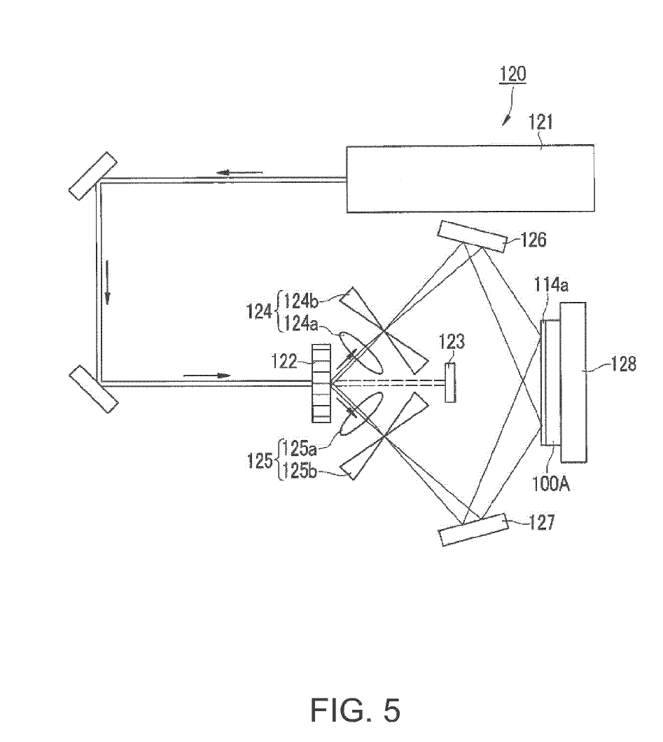

A method for manufacturing the above-described polarizing element 100 is now described with reference to FIG. 4 and FIG. 5.

FIGS. 4A through 4E are sectional views of the polarizing element showing its manufacturing steps. FIG. 5 is a schematic block diagram of an exposure apparatus used in the manufacturing process of the polarizing element

Referring to FIG. 4A, the base substrate 100A such as a transparent glass substrate is firstly provided. The base layer 115 is formed by depositing for example a silicon oxide film on the one face of the base substrate 100A by sputtering or the like. The metal film 112a is then formed on the base layer 115 by depositing an aluminum film all over the base layer 115 by sputtering or the like. A seed layer 116a is further formed on the metal film 112a by depositing a silicon oxide film all over the metal film 112a by sputtering or the like.

Referring now to FIG. 4B, a resist layer 114a is formed by applying a resist on the seed layer 116a and baking the resist. The resist layer 114a is then exposed by a dual-beam interference exposure method using a laser beam having a wavelength of for example 266 nm. The exposure here is carried out such that a fine stripe pattern having a pitch (for example 140 nm) which is smaller than the wavelength of the visible light. After the exposure, the resist layer 114a is further baked (post exposure bake: PEB) and then developed. Through such process, an etching mask 114 having the stripe pattern is formed on the seed layer 116a as shown in FIG. 4C.

An exposure apparatus used in the dual-beam interference exposure method can be for example the one shown in FIG. 5. A exposure apparatus 120 has a laser beam source 121 irradiating the exposure light, a diffraction type beam splitter 122, a monitor 123, beam expanders 124, 125, mirrors 126, 127 and a stage 128 on which the base substrate 100A is placed.

The laser beam source 121 can be for example an Nd: YVO4 laser device having the fourth harmonic wavelength of 266 nm. The diffraction type beam splitter 122 is a splitting means that splits a single laser beam emitted from the laser beam source 121 into two laser beams. The diffraction type beam splitter 122 generates two diffracted beams (±1 order) that have the same intensity when the incident laser beam is a transverse electric (TE) polarization wave. The monitor 123 receives the light beams from the diffraction type beam splitter 122 and transforms them into electric signals. Adjustments of the intersection angle of the two laser beams and the like can be conducted based on the transformed electric signal in the exposure apparatus 120.

The beam expander 124 has a lens 124a and a space filter 124b. The beam expander 124 expands the diameter of one of the two laser beams split by the laser beam source 121 to for example about 300 mm. The beam expander 125 also has a lens 125a and a space filter 125b and expands the diameter of the other of the two laser beams. The mirrors 126, 127 respectively reflect the laser beams transmitted through the beam expanders 124, 125 toward the stage 128. The mirrors 126, 127 generate an interferential light beam by crossing the reflected laser beams and the interferential light beam enters into the resist layer 114a on the base substrate 100A.

The resist layer 114a is irradiated with the interferential light beam by using the above-described exposure apparatus 120 and the etching mask 114 having the stripe pattern whose pitch is smaller than the wavelength of the laser beam source 121 can be formed.

The seed layer 116a and the metal film 112a are partially removed so as to form the openings 113 in the metal film 112a by a dry-etching process through the etching mask 114. In this way, the polarizing element member 112 including the metal film 112M that has the plurality of the slit-shaped openings 113 is formed on the base substrate 100A as shown in FIG. 4D. Furthermore, the seed layer 116 is formed on the upper face of the metal film 112M such that the seed layer 116 extends in the direction in which the metal film 112M extends.

According to the embodiment, the etching process of the seed layer 116a and the metal film 112a is performed together because it can save time. However if it is not possible to remove the seed layer and the metal film simultaneously due to the material difference or the like, the etching process can be separately performed by using different etching gases appropriate for the seed layer and the metal film. In either case, the etching should be carried out so as to leave the seed layer 116 on the metal film 112M after the patterning.

Referring now to FIG. 4E, the coating film 117 is formed on the polarizing element member 112 (metal film 112M) by depositing a silicon oxide film by sputtering or the like. At this point the seed layer 116 made of the silicon oxide has been formed on the upper face of the metal film 112M. Accordingly, the coating film 117 preferentially grows on the seed layer 116, the growing crystal grains contact with the upper area of the opening 113 and blocks up the open end of the opening 113. Once the open end is closed with the crystal grains, deposition (sputtering grains and the like) forming the coating film 117 cannot penetrate into the opening 113. The inside of the opening 113 remains as the hollow space and the coating film 117 is formed on the polarizing element member 112.

Though the above-described process, the polarizing element 100 having the polarizing element member 112 in which the opening 113 is the hollow space can be manufactured.

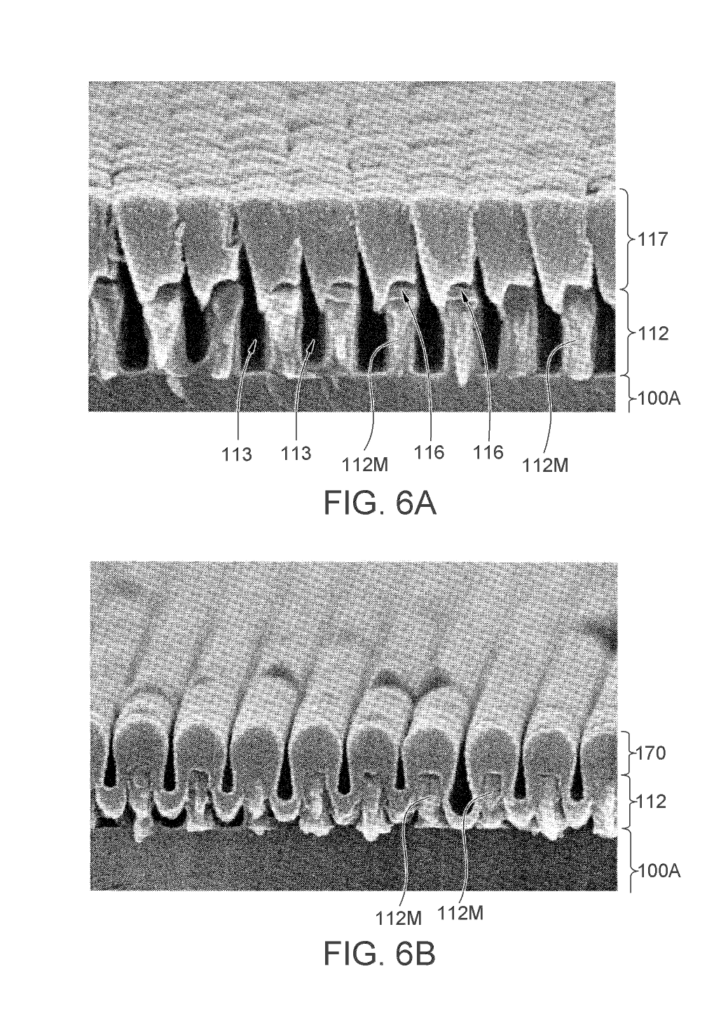

FIG. 6A is an electron micrograph of the polarizing element manufactured by the method according to the above-described embodiment. Referring to FIG. 6A, in the polarizing element according to the embodiment, the crystal grains forming the coating film 117 grows upward from the seed layer 116 formed on the metal film 112M. The adjacent crystal grains contact each other and close the opening 113. While the inside of the opening 113 surrounded by the base substrate 100A, the metal film 112M and the coating film 117 is the hollow space. According to the manufacturing method of the embodiment, it is possible to easily manufacture the polarizing element 100 having the optical characteristics which were described with reference to FIG. 3A.

FIG. 6B is an electron micrograph of a polarizing element that includes the polarizing element member 112 formed on the base substrate 100A but manufactured by a conventional method in which the seed layer 116 is not formed. Referring to FIG. 6B, it can be seen that a silicon oxide film 170 is formed not only on the metal film 112M but also on the surface of the base substrate 100A where is exposed between the metal films 112M and on the side faces of the metal film 112M when the silicon oxide film 170 is deposited on the metal film 112M without providing the seed layer. The opening between the metal films 112M is filled with the silicon oxide film. When the silicon oxide having a different refraction index is filled between the metal films 112M like this, the optical characteristics of polarizing element is worsened in the same manner as the case described above with reference to FIG. 3C.

When FIG. 6A is compared with FIG. 6B, the surface of the coating film 117 in the polarizing element of the embodiment is flatter and smoother than the surface of the silicon oxide film 170 in which concaves are formed corresponding to the regions among the metal films 112M. Therefore, according to the embodiment, it is possible to form a film or a functional member on the coating film 117 more easily and precisely in the polarizing element.

The seed layer 116 made of the silicon oxide was formed on the metal film 112M then the formation of the coating film 117 made of the silicon oxide begins from the seed layer 116 in the above-described embodiment. Even in the case where the seed layer 116 and the coating film 117 are made of a transparent conductive material such as ITO, it is also possible to fabricate the polarizing element in which the opening 113 is maintained as the hollow space. In this case, the polarizing element 100 can also serve as an electrode.

### Second Embodiment

A liquid crystal device having the polarizing element according to the invention as a reflective polarizing layer embedded therein is now described with reference to the accompanying drawings.

The liquid crystal device in this embodiment is a vertically aligned mode liquid crystal device in which the initial alignment is vertical and which has a liquid crystal layer having an anisotropic negative refractive index. The liquid crystal device in this embodiment is also a color liquid crystal device in which a color filter is provided on a substrate. A single pixel includes three sub-pixels that emit colored light beams of red (R), green (G) and blue (B) respectively. A minimum unit forming a display area is referred as a “sub-pixel region” and a set of the sub-pixels (R, G, B) is referred as a “pixel region”.

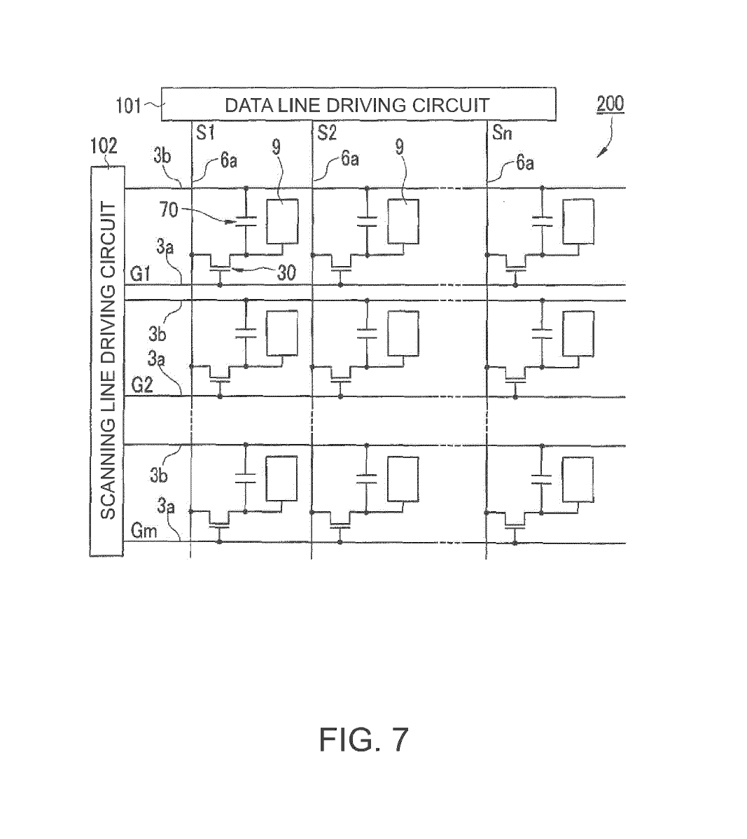

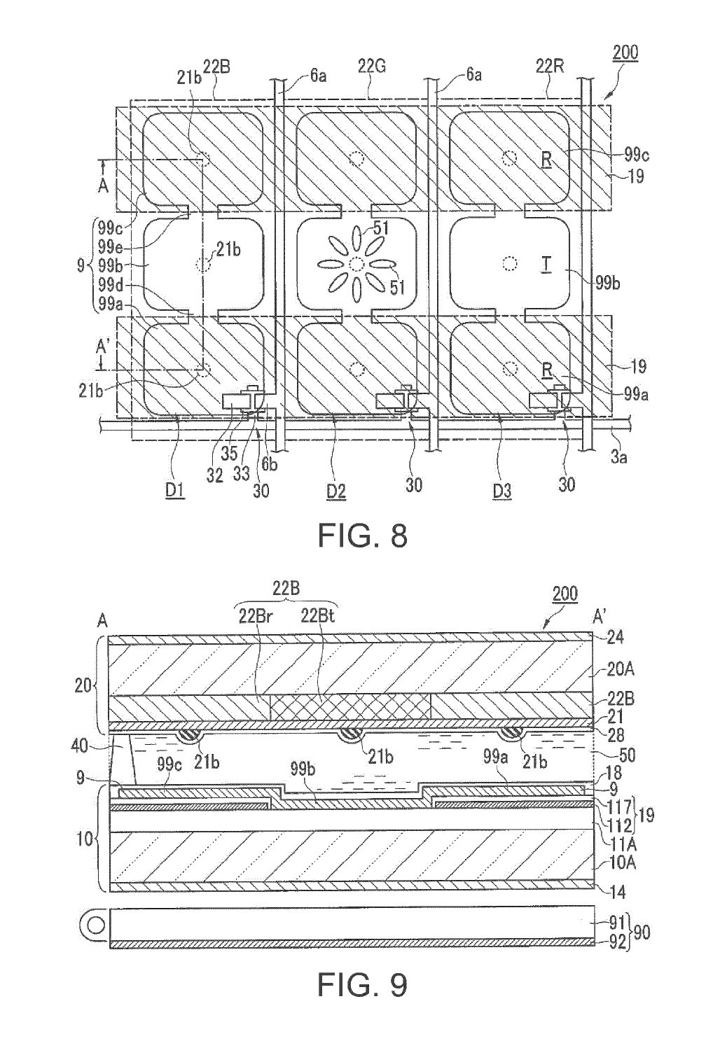

FIG. 7 is an equivalent circuit schematic of a plurality of the sub-pixel regions arranged in matrix in a liquid crystal device 200 according to the second embodiment. FIG. 8 is a planer view of a single pixel region (three sub-pixel regions) in the liquid crystal device 200. FIG. 9 is a partial sectional view of the pixel region along the line A-A′ in FIG. 8. A scale size of each layer or member in the drawings is appropriately set in order to make the layer or member recognizable.

Referring to FIG. 7, the sub-pixel regions are arranged in matrix and form an image display region of the liquid crystal device 200. A pixel electrode 9 and a thin film transistor (TFT) 30 which controls switching of the pixel electrode 9 are formed in each sub-pixel region. A data line 6a extending from a data line driving circuit 101 is electrically coupled to a source of the TFT 30. The data line driving circuit 101 supplies image signals S1, S2, . . . , Sn respectively to corresponding pixels through the data line 6a. The image signals S1, S2, . . . , Sn can be supplied in a line-sequentially in this order or they can be provided by groups corresponding to a set of adjacent data lines 6a.

A scan line 3a extending from a scan line driving circuit 102 is electrically coupled to a gate of the TFT 30. Scan signals G1, G2, . . . ,Gm which are supplied from the scan line driving circuit 102 at predetermined timings are sequentially applied in a pulse form to the corresponding scan lines 3a. The pixel electrode 9 is electrically coupled to a drain of the TFT 30. The image signals S1, S2, . . . , Sn supplied through the data lines 6a are written into the corresponding pixel electrodes 9 at a predetermined timing by turning on the TFTs 30 which are the switching elements for a predetermined time period.

The image signals S1, S2, . . . Sn having predetermined signal levels are written into liquid crystal through the pixel electrodes 9. The signals are then retained between the pixel electrodes 9 and a common electrode which opposes the pixel electrodes 9 with the liquid crystal interposed therebetween for a certain period. In order to prevent the image signals written into the liquid crystal from leaking, a storage capacitor 70 is provided in parallel to liquid crystal capacitance that is formed between the pixel electrodes 9 and the common electrode. The storage capacitor 70 is situated between the drain of the TFT 30 and a capacitor line 3b.

A structure of the liquid crystal device 200 is now described in detail with reference to FIG. 8 and FIG. 9.

Referring to FIG. 9, the liquid crystal device 200 includes a liquid crystal panel having a TFT array substrate 10, an opposing substrate 20 and a liquid crystal layer 50 interposed therebetween. The liquid crystal layer 50 is enclosed between the TFT array substrate 10 and the opposing substrate 20 by an unshown sealant provided along the outer edge of the region where the TFT array substrate 10 and the opposing substrate 20 oppose each other. A backlight 90 (illuminating device) that includes a light-guiding plate 91 and a reflecting plate 92 is provided on the back side (the lower side in the drawing) of the TFT array substrate 10.

Looking at the planer configuration of the pixels shown in FIG. 8, square shaped regions defined by the data lines 6a and the scan lines 3a that extend vertically and horizontally in the display region respectively correspond to sub-pixels D1-D3. In this embodiment, color filters 22B, 22G, 22R are provided corresponding to the planar regions of the sub-pixels. The color filters 22B, 22G, 22R are respectively colored in blue (B), green (G) and red (R) and the set of the filters is arranged in a cyclic manner. A set of the sub-pixels D1-D3 corresponding to the three colored area forms a single pixel which performs display by mixing the three colors.

The pixel electrode 9 is formed with respect to each sub-pixel. The pixel electrode 9 is electrically coupled to the TFT 30 which is placed at the intersection of the scan line 3a and the data line 6a. The TFT 30 includes a semiconductor layer 35 made of amorphous silicon or the like, a source electrode 6b, a drain electrode 32, and a gate electrode 33. The drain electrode 32 is electrically coupled to the pixel electrode 9 through an unshown contact hole.

The pixel electrode 9 includes three island shaped parts 99a, 99b, 99c and coupling parts 99d, 99e that electrically couple the island shaped parts. In other words, the sub-pixel is divided into three sub-dots whose shapes are substantially the same as the island shaped parts 99a, 99b, 99c.

In the liquid crystal device having a color filter, an aspect ratio of a single sub-pixel is typically about 3:1. If three sub-dots (the island shaped parts 99a, 99b, 99c) are provided in a sub-pixel D like the embodiment, the shape of each sub-dot can be made close to circle or a regular polygon. This is preferable because such liquid crystal device can have a wider viewing angle in all directions in 360°. Though the shape of each sub-dot (the island shaped parts 99a-99c) shown in FIG. 8 is a rotundate square, the shape is not limited. The shape of the sub-dot can be circle, octagon and other polygons. When the pixel electrode 9 is described in other way, slits (parts where the coupling parts 99d, 99e are removed) which are made by partially cutting out the electrode are provided between the island shaped parts 99a, 99b, 99c.

A dielectric protrusion 21b (an alignment controller) is formed on a common electrode 21 of the opposing substrate 20 and at the position where corresponds to the center of each of the island shaped parts 99a, 99b, 99c. A reflective polarizing layer 19 is formed corresponding to the planar region of the island shaped part 99a that is the closer island shaped part to the TFT 30 and to the planar region of the island shaped part 99c that is the further island shaped part from the TFT 30. When we look at this from over all the pixels, the strip shaped reflective polarizing layer 19 is formed so as to extend along the direction in which the scan line 3a extends and to cover the island shaped parts 99a, and the strip shaped reflective polarizing layer 19 is also provided so as to extend along the direction in which the scan line 3a extends and to cover the island shaped parts 99c.

The planar region of the island shaped parts 99a, 99c where is covered with the reflective polarizing layer 19 is a reflective display region in the sub-pixel. An area which is an opening area is the reflective polarizing layer 19 (or the area between the strip shaped reflective polarizing layers 19) and corresponds to the island shaped part 99b is a transmissive display region in the sub-pixel.

In this embodiment, the pixel electrode 9 is a transparent conductive film made of a transparent conductive material such as indium tin oxide (ITO). The reflective polarizing layer 19 is the polarizing element that includes the above-described polarizing element member 112 and the coating film 117 covering the polarizing element member 112.

Though not shown in the drawing, the storage capacitor 70 which is shown in FIG. 7 is provided in each sub-pixel. The storage capacitor 70 is a commonly used capacitor in this embodiment.

Referring now to the sectional view of FIG. 9, a circuit layer 11A including the TFT 30 is formed on the liquid crystal layer 50 side of a substrate body 10A which is made of glass, plastic or the like in the TFT array substrate 10. The reflective polarizing layer 19 is formed partially on the circuit layer 11A.

The reflective polarizing layer 19 includes the polarizing element member 112 and the coating film 117 that have the same structure as those shown in FIG. 1 and are deposited in this order from the circuit layer 11A. In this embodiment, the metal film of the circuit layer 11A is an aluminum film and the coating film is a transparent insulating film made of silicon oxide.

The pixel electrode 9 is formed so as to extend over the coating film 117 of the reflective polarizing layer 19 and the circuit layer 11A which is situated in the area where the reflective polarizing layer 19 is not formed. An alignment film 18 (vertical alignment film) made of polyimide or the like is formed so as to cover the pixel electrode 9.

Though not shown in FIG. 8, a pixel contact hole that penetrates an inter-layer insulating film between the pixel electrode 9 and the TFT 30 and reaches to the drain electrode 32 is formed in the planar region of the drain electrode 32. The drain electrode 32 of the TFT 30 is electrically coupled to the pixel electrode 9 through the pixel contact hole.

In the embodiment, the reflective polarizing layer 19 is formed so as to avoid the pixel contact hole forming region because the reflective polarizing layer 19 is placed between the pixel electrode 9 and the circuit layer 11A. In other words, the reflective polarizing layer 19 made of the metal film will not contact with the pixel electrode 9 in the pixel contact hole. Alternatively, the pixel contact hole can be formed in the transmissive display region (the area where the reflective polarizing layer 19 is not formed).

In opposing substrate 20, a color filter 22B and the common electrode 21 which is made of a transparent conductive material such as ITO are formed on the face of a substrate body 20A which is closer to the liquid crystal layer 50. The substrate body 20A is made of a transparent material such as glass and quartz. Three protrusions 21b protruding toward the liquid crystal layer 50 side are formed on the common electrode 21. An alignment film 28 (vertical alignment film) is formed so as to cover the protrusions 21b and the common electrode 21.

The color filter 22B is divided into two color material regions 22Br, 22Bt in the sub-pixel region. The color material region 22Br is situated an area where overlaps the reflective display region (in other words the area where the reflective polarizing layer 19 is formed). The color material region 22Bt is situated an area where overlaps the transmissive display region (in other words the opening region of the sub-pixel). In this way, the different color material regions 22Br, 22Bt are used between the reflective display and the transmissive display to display in color. Thereby an appropriate color intensity display according to modes of the display is possible and it is possible to achieve a high image quality.

A polarizing plate 14 is provided on the face of the substrate body 10A which is opposite to the liquid crystal layer 50. A polarizing plate 24 is provided on the face of the substrate body 20A which is opposite to the liquid crystal layer 50. On the side of the polarizing plate 24 (a negative C-plate and the like) which is the display side, an optical compensator that compensate the viewing angle.

The liquid crystal device 200 having the above-described configuration performs an image display when an image signal (voltage) is applied to the pixel electrode 9 through the TFT 30, a electric field is generated between the pixel electrode 9 and the common electrode 21 in the thickness direction of the liquid crystal layer 50, the electric field drives liquid crystal and the transmittancetransmittance/the reflection rate in each sub-pixel is changed. The liquid crystal device 200 is the vertical alignment mode liquid crystal device.

When a voltage is applied, liquid crystal molecules 51 are aligned in a substantially radial pattern centered at each dielectric protrusion 21b by the alignment control action by the peripherals of the island shaped parts 99a-99c in the pixel electrode 9 and the dielectric protrusions 21b provided at the centers of the island shaped parts 99a-99c. Thereby a high contrast display can be obtained in all directions.

The liquid crystal device has the reflective polarizing layer 19 corresponding to the reflective display region. Therefore a fine contrast can be obtained both in the transmissive display and the reflective display without using a multi-gap structure. Furthermore, the reflective polarizing layer 19 is the wire grid type polarizing element according to the invention in which the polarizing element member 112 is covered with the coating film 117. Therefore it is possible to prevent the pixel electrode 9 formed on the reflective polarizing layer 19 from entering into the openings in the polarizing element member 112. This prevents the optical characteristics of the reflective polarizing layer 19 from being worsen. Consequently, fine optical characteristics both in the transmissivity and the contrast (polarization selectivity) can be obtained at the reflective polarizing layer 19. In this way, it is possible to acquire a high contrast reflective display.

Moreover, the coating film 117 has the flat and smooth surface as shown in FIG. 6A so that the surface of the pixel electrode 9 and the alignment film 18 can also be made flat and smooth. Thereby the thickness of the liquid crystal layer can be precisely controlled and this can improve the display quality.

### Third Embodiment

A liquid crystal device according to a third embodiment is now described with reference to the accompanying drawings. The liquid crystal device according to the third embodiment adopts a fringe field switching (FFS) method which is one of horizontal electric field methods in which the alignment is controlled by applying an electric field of the substrate face direction (horizontal direction) to the liquid crystal so as to display an image. The liquid crystal device according to the third embodiment is the color liquid crystal device having the color filter on the substrate.

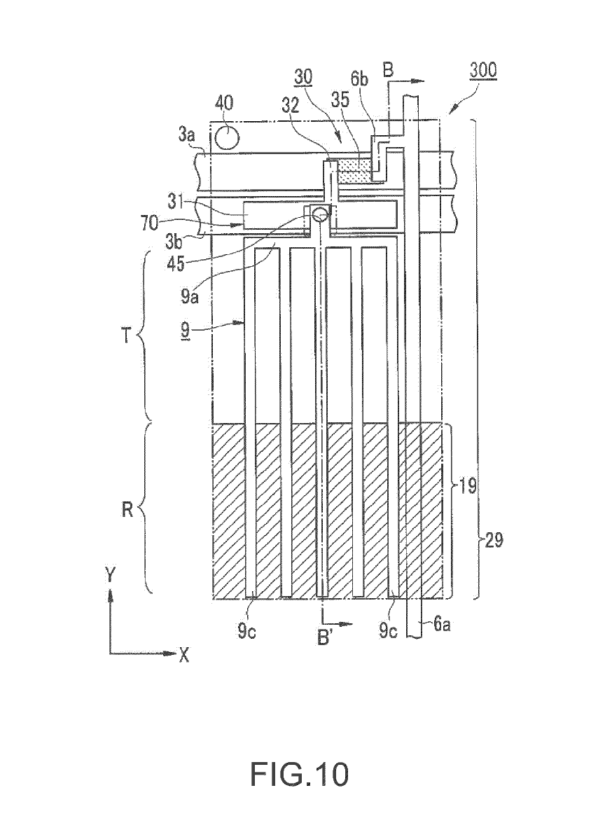

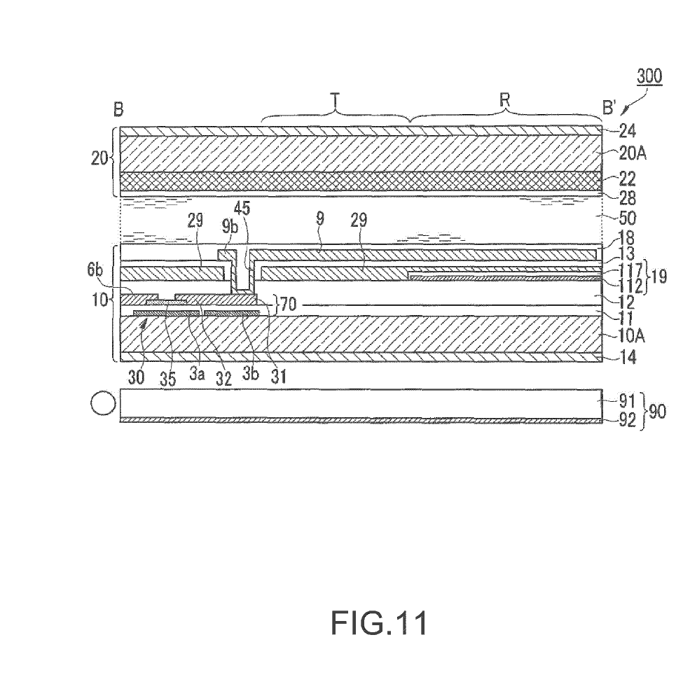

FIG. 10 is a plan view of a single sub-pixel region in a liquid crystal device 300 according to the third embodiment. FIG. 11 is a sectional view of the sub-pixel region along the line B-B′ in FIG. 10.

A scale size of each layer or member in the drawings is appropriately set in order to make the layer or member recognizable. In the drawings which are referred in the following description, the identical numerals are given to the same components as those of the second embodiment described with reference to FIGS. 7 through 9 and those explanations will be omitted.

Referring to FIG. 11, the liquid crystal device 300 includes a liquid crystal panel having the TFT array substrate 10 (a first substrate), the opposing substrate 20 (a second substrate) and the liquid crystal layer 50 interposed therebetween. The liquid crystal layer 50 is enclosed between the substrates 10 and 20 by an unshown sealant provided along the outer edge of the region where the TFT array substrate 10 and the opposing substrate 20 oppose each other. The backlight 90 (illuminating device) that includes the light-guiding plate 91 and the reflecting plate 92 is provided on the back side (the lower side in the drawing) of the TFT array substrate 10.

Referring to FIG. 10, the pixel electrode 9 (a first electrode) having a comb-like shape whose longer side is placed in the direction in which the data line 6a extends when it is viewed in plan is provided in the sub-pixel region of the liquid crystal device 300. A common electrode 29 (a second electrode) is also provided all over the sub-pixel region so as to overlaps the pixel electrode 9 when it is viewed in plan. A column shaped spacer 40 which retains a predetermined space between the TFT array substrate 10 and the opposing substrate 20 is provided at the left corner of the sub-pixel region as shown in the drawing.

The pixel electrode 9 includes a strip electrode part 9c that extends in the direction in which the data line 6a extends and provided in the plural number (five in the drawing), a connecting part 9a that is coupled to the TFT 30 side (+Y-side) edge of the strip electrode part 9c and extends in the direction in which the scan line 3a extends, and a contact part 9b that extends from around the center of the connecting part 9a that extends in the direction of the scan line 3a to the TFT 30 side (+Y-side).

The common electrode 29 is a transparent electrode that is formed all over the pixel region shown in FIG. 11 to have a flat face. The reflective polarizing layer 19 is formed in the area where overlaps a part of the common electrode 29. The reflective polarizing layer 19 is the polarizing element according to the invention and which includes the polarizing element member made of a light-reflective metal film having a fine slit structure.

The shape of the common electrode 29 can be a square whose size is substantially same as the size of the sub-pixel region shown in FIG. 2A. In this case, a common electrode wiring that extends through the plurality of the common electrodes is provided and the common electrodes that are arranged in the direction in which the common electrode wiring extends will be electrically coupled each other.

The liquid crystal device 300 according to the embodiment includes a single sub-pixel region as shown in FIG. 10. The area where the reflective polarizing layer 19 is formed in the square-shaped planar region in which the pixel electrode 9 is provided is a reflective display region R with which display is performed by reflecting and modulating the light beam that is entered from the outside of the opposing substrate 20 and goes through the liquid crystal layer 50. A light transmissive area where the reflective polarizing layer 19 is not formed in the region where the pixel electrode 9 is provided is a transmissive display region T with which display is performed by modulating the light beam that is entered from the backlight 90 and goes through the liquid crystal layer 50.

The TFT 30 is coupled to the data line 6a that extends in the longitudinal direction (the X-axis direction) of the pixel electrode 9 and to the scan line 3a that extends in the direction orthogonal to the data line 6a (the Y-axis direction). The capacitor line 3b which extends in parallel and adjacent to the scan line 3a is also provided. The TFT 30 includes the semiconductor layer 35 that is made of an amorphous silicon film and formed partially in the planer region of the scan line 3a, the source electrode 6b and the drain electrode 32 that are formed so as to partially overlap the scan line 3a. A part of the scan line 3a that lies on top of the semiconductor layer 35 serves as the gate electrode of the TFT 30.

The source electrode 6b is formed to have a substantially inversed-L shape that branches from the data line 6a and extends toward the semiconductor layer 35 when it is viewed as a plane. The drain electrode 32 extends to the pixel electrode 9 side (−Y side) from the position where it overlaps the semiconductor layer 35. A capacitor electrode 31 having a square shape when it is viewed in plan is electrically coupled to the end section of the drain electrode 32. The contact part 9b that protrudes out to the scan line 3a side at the edge of the pixel electrode is placed on the capacitor electrode 31. The capacitor electrode 31 is electrically coupled to the pixel electrode 9 through a pixel contact hole 45 that is situated at the position where the capacitor electrode 31 and the pixel electrode 9 overlap each other. The capacitor electrode 31 is placed within the planer region of the capacitor line 3b. The capacitor electrode 31 opposes the capacitor line 3b in the thickness direction and forms the storage capacitor 70.

The liquid crystal device 300 in the third embodiment is the FFS type liquid crystal device having the pixel electrode 9 and the common electrode 29 opposing the pixel electrode 9. Therefore, a relatively large capacitance is formed in the area where the pixel electrode 9 and the common electrode 29 overlap each other when a voltage is applied to the pixel electrode 9 in order to conduct the display. Thereby the storage capacitor 70 can be omitted in the liquid crystal device 300. In this configuration, the area where the capacitor electrode 31 and the capacitor line 3 are formed can also be used as the display region, which means the aperture ratio of the sub-pixel is increased and a brighter display becomes possible.

Looking at the sectional structure shown in FIG. 11, the liquid crystal layer 50 is provided between the TFT array substrate 10 and the opposing substrate 20 which opposes each other. The TFT array substrate 10 has the light transmissive substrate body 10A which is made of glass, quartz, plastic or the like as a main body. The scan line 3a and the capacitor line 3b are formed on the inner face (face closer to the liquid crystal layer 50) of the substrate body 10A. A gate insulating film 11 which is made of a transparent insulating film such as silicon oxide is formed so as to cover the scan line 3a and the capacitor line 3b.

The semiconductor layer 35 made of amorphous silicon is formed on the gate insulating film 11. The source electrode 6b and the drain electrode 32 are formed such that a part of them is situated on the semiconductor layer 35. The capacitor electrode 31 and the drain electrode 32 are formed so as to have the single body.

The semiconductor layer 35 is situated so as to oppose the scan line 3a with the gate insulating film 11 interposed therebetween. The part of the scan line 3a opposing the semiconductor layer 35 serves as the gate electrode of the TFT 30. The capacitor electrode 31 is placed so as to oppose the capacitor line 3b with the gate insulating film 11 interposed therebetween. The storage capacitor 70 whose dielectric film is the gate insulating film 11 is formed in the area where the capacitor electrode 31 opposes the capacitor line 3b.

An inter-layer insulating film 12 made of silicon oxide or the like is formed so as to cover the semiconductor layer 35, the source electrode 6b, the drain electrode 32 and the capacitor electrode 31. The reflective polarizing layer 19 according to the invention which includes the polarizing element member 112 and the coating film 117 is partially formed on the inter-layer insulating film 12. In this embodiment, the metal film (112M) forming the polarizing element member 112 is also made of aluminum. The coating film 117 covering the polarizing element member 112 is made of a silicon oxide film.

The common electrode 29 made of a transparent conductive film is formed all over the inter-layer insulating film 12 and the reflective polarizing layer 19. The coating film 117 isolates the common electrode 29 from the polarizing element member 112 in the reflective polarizing layer 19.

Though the common electrode 29 is formed so as to cover the reflective polarizing layer 19 in FIG. 11, the common electrode 29 and the reflective polarizing layer 19 can be layout in the same plane. In this case, it is preferable that the coating film 117 be made of a transparent conductive material such as ITO because the reflective polarizing layer 19 can be used as a part of the common electrode.

An electrode part insulating film 13 made of silicon oxide or the like is formed so as to cover the common electrode 29. The pixel electrode 9 made of a transparent conductive material such as ITO is formed on the electrode part insulating film 13,. The pixel contact hole 45 that penetrates the inter-layer insulating film 12 and the electrode part insulating film 13 and reaches to the capacitor electrode 31 is provided. The pixel electrode 9 is electrically coupled to the capacitor electrode 31 through a part of the contact part 9b of the pixel electrode 9 which fills the pixel contact hole 45. At least an opening is provided in the polarizing element member 112 of the reflective polarizing layer 19 corresponding to the forming region of the pixel contact hole 45. This prevents the pixel electrode 9 from contacting with the polarizing element member 112 which is made of the metal film. The alignment film 18 (horizontal alignment film) made of polyimide or the like is formed so as to cover the pixel electrode 9.

On the inner face (face closer to the liquid crystal layer 50) of the opposing substrate 20, a color filter 22 and the alignment film 28 (horizontal alignment film) are deposited so as to form layers. On the outer face of the opposing substrate 20, the polarizing plate 24 which is the counterpart of the polarizing plate 14 that is provided the outer face of the TFT array substrate 10 is provided.

It is preferable that the color filter 22 be divided into two regions having different chromaticity in the pixel region. More specifically, it is preferable that the color filter have the same structure as that of the above-described second embodiment. The one in which a first color material region corresponding to the transmissive display region T and a second color material region corresponding to the reflective display region R are partially arranged is preferably adopted. In this case, the chromaticity of the first color material region situated in the transmissive display region T is stronger than the chromaticity of the second color material region. This is because the color of the display light beam can be made same between the transmissive display region where the display light beam goes through the color filter 22 only once and the reflective display region where the display light beam goes through the color filter 22 twice. In this way, the difference in vision between the reflective display and the transmissive display can be eliminated and the display quality can be improved.

The liquid crystal device 300 having such structure is the FFS type liquid crystal device. When an image signal (voltage) is applied to the pixel electrode 9 through the TFT 30, an electric field whose direction is the substrate face direction (the X-axis direction in FIG. 10) is generated between the pixel electrode 9 and the common electrode 29. The electric field drives the liquid crystal and an image can be displayed by changing the transmittance/the reflection rate in each sub-pixel.

The alignment films 18 and 28 that oppose each other with the liquid crystal layer 50 interposed therebetween are processed with rubbing in the same direction when they are viewed in plan. The liquid crystal molecules forming the liquid crystal layer 50 horizontally align along the rubbing direction between the substrates 10 and 20 when a voltage is not applied to the pixel electrode 9. If the electric filed formed between the pixel electrode 9 and the common electrode 29 works in the crystal layer 50, the liquid crystal molecules realign in the width direction of the strip electrode part 9c (the X-axis direction) shown in FIG. 10. The liquid crystal device 300 utilizes the birefringence caused by the difference in the alignment state of the liquid crystal molecules in order to perform a contrast display. When the liquid crystal device 300 is activated, the voltage of the common electrode 29 is retained at a constant level at which a predetermined voltage difference is generated between the pixel electrode 9 and the common electrode 29.

In the same way as the above-described embodiment, the liquid crystal device 300 also has the reflective polarizing layer 19 corresponding to the reflective display region. Therefore a fine contrast can be obtained both in the transmissive display and the reflective display without using a multi-gap structure. Furthermore, the reflective polarizing layer 19 is the wire grid type polarizing element according to the invention in which the polarizing element member 112 is covered with the coating film 117. Therefore it is possible to prevent the pixel electrode 9 formed on the reflective polarizing layer 19 from entering into the openings in the polarizing element member 112. This prevents the optical characteristics of the reflective polarizing layer 19 from being worsen. Consequently, fine optical characteristics both in the transmissivity and the contrast (polarization selectivity) can be obtained at the reflective polarizing layer 19. In this way, it is possible to acquire a high contrast reflective display.

Moreover, the coating film 117 has the flat and smooth surface as shown in FIG. 6A so that the surface of the common electrode 29, the electrode part insulating film 13, the pixel electrode 9 and the alignment film 18 which are formed on the coating film 117 can also be made flat and smooth. Thereby it is possible to precisely control the distance between the pixel electrode 9 and the common electrode 29 which depends on the thickness of the electrode part insulating film 13, and the thickness of the liquid crystal layer. This helps to improve the display quality.

Furthermore, according to the liquid crystal device 300 of the embodiment, the thickness of the liquid crystal layer is constant between the transmissive display region T and the reflective display region R in the display region. Accordingly the difference in the driving voltage will not be generated in these two regions and this effectively prevents the display state from differing between the reflective display and the transmissive display.

Moreover, according to the third embodiment, the reflective polarizing layer 19 is provided in the TFT array substrate 10 side. Therefore, outside light will not be reflected at the metal wirings and the like which are formed on the TFT array substrate 10 together with the TFT 30 and this effectively prevents the display quality from being deteriorated. Furthermore, since the pixel electrode 9 is made of the transparent conductive material, the outside light beam that goes through the liquid crystal layer 50 and then entered into the TFT array substrate 10 will not be reflected diffusely by the pixel electrode 9. Consequently, it is possible to obtain a fine visibility.

### Fourth Embodiment

A liquid crystal device according to a fourth embodiment is now described with reference to the accompanying drawings. The liquid crystal device according to the fourth embodiment adopts an in-plane switching (IPS) method which is one of the horizontal electric field methods in which the alignment is controlled by applying an electric field of the substrate face direction (horizontal direction) to the liquid crystal so as to display an image. The liquid crystal device according to the third embodiment is the color liquid crystal device having the color filter on the substrate.

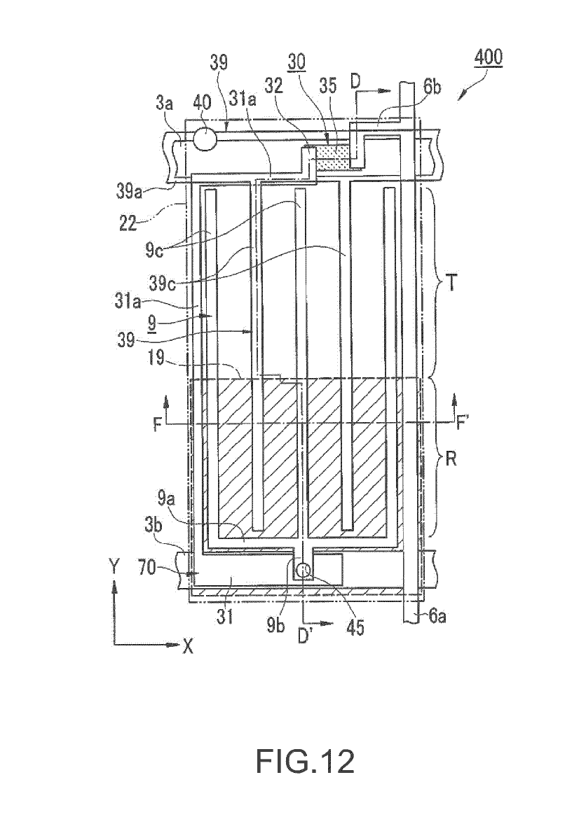

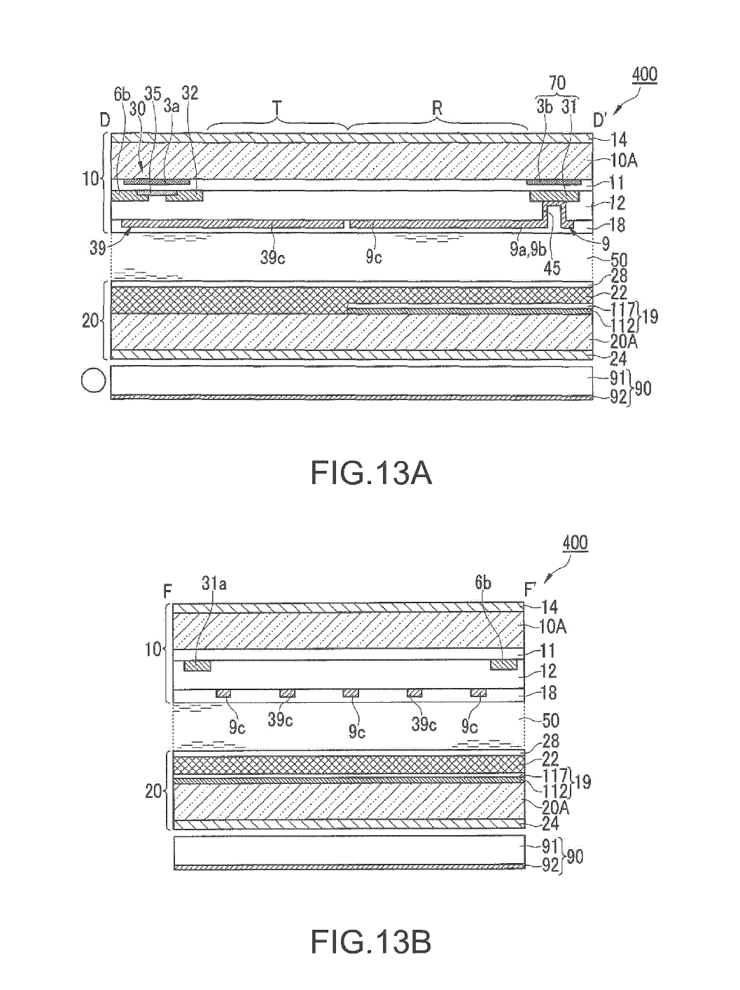

FIG. 12 is a plan view of a single sub-pixel region in a liquid crystal device 400 according to the fourth embodiment. FIG. 13A is a partial sectional view of the sub-pixel region along the line D-D′ in FIG. 12 and FIG. 13B is a partial sectional view of the sub-pixel region along the line F-F′ in FIG. 12.

A scale size of each layer or member in the drawings is appropriately set in order to make the layer or member recognizable. In the drawings which are referred in the following description, the identical numerals are given to the same components as those of the third embodiment described with reference to FIGS. 10 and 11 and those explanations will be omitted.

Referring to FIG. 13, the liquid crystal device 400 includes the TFT array substrate 10 (first substrate), the opposing substrate 20 (second substrate) and the liquid crystal layer 50 interposed therebetween. The liquid crystal layer 50 is enclosed between the substrates 10 and 20 by an unshown sealant which is provided along the outer edge of the region where the TFT array substrate 10 and the opposing substrate 20 oppose each other. The backlight 90 (illuminating device) that includes the light-guiding plate 91 and the reflecting plate 92 is provided on the back side (the lower side in the drawing) of the opposing substrate 20.

Referring to FIG. 12, the data line 6a that extends in the longitudinal direction (the Y-axis direction) of the sub-pixel region and the scan line 3a that extends in the direction orthogonal to the data line 6a (the X-axis direction) are formed in the sub-pixel region in the liquid crystal device 400. The capacitor line 3b is also provided such that it extends along the edge of the sub-pixel region that is opposite to the edge closer to the scan line 3a. The pixel electrode 9 (first electrode) having a comb-like shape whose longer side is placed in the direction in which the data line 6a extends when it is viewed in plan is provided. A common electrode 39 (the second electrode) having a comb-like shape when it is viewed in plan is also provided. The column shaped spacer 40 is placed at the left corner of the sub-pixel region as shown in the drawing.

The pixel electrode 9 includes the strip electrode part 9c that extends in the direction (the Y-axis direction) in which the data line 6a extends and provided in the plural number (three in the drawing), the connecting part 9a that is coupled to the capacitor line 3b side (-Y-side) edge of the strip electrode part 9c and extends in the direction (the X-axis direction) in which the capacitor line 3b extends, and the contact part 9b that extends from around the center of the connecting part 9a and extends out to the capacitor line 3b.

The common electrode 39 and the strip electrode part 9c of the pixel electrode 9 are alternatively arranged. The common electrode 39 includes a strip electrode part 39c that extends in the direction (the Y-axis direction) parallel to the strip electrode part 9c and provided in the plural number (two in the drawing), and a main line part 39a that is coupled to the scan line 3a side edge of the strip electrode part 39c and extends in the direction (the Y-axis direction) in which the scan line 3a extends. The common electrode is an electrode member that has the comb-like shape when it is viewed in plan and extends throughout the plurality of the sub-pixel regions arranged in the X-axis direction.

In the sub-pixel region shown in FIG. 12, a voltage is applied between the three strip electrode parts 9c that extend along the data line 6a and the two strip electrode parts 39c that are placed among the strip electrode parts 9c. When the voltage is applied, an electric field of the substrate face direction (horizontal electric field) is formed in the liquid crystal in the sub-pixel region.

The TFT 30 is placed around the intersection of the scan line 3a and the data line 6a. The TFT 30 includes the semiconductor layer 35 that is made of amorphous silicon and partially formed in the planar region of the scan line 3a, the source electrode 6b that partially overlaps with the semiconductor layer 35, and the drain electrode 32. The part of the scan line 3a opposing the semiconductor layer 35 serves as the gate electrode of the TFT 30.

The source electrode 6b is formed to have a substantially inversed-L shape that branches from the data line 6a and extends toward the semiconductor layer 35 when it is viewed as a plane. The end part of the drain electrode 32 which is closer to the pixel electrode is electrically coupled with a connecting wire 31a. The connecting wire 31a starts from the TFT 30, passes the outside of the pixel electrode and extends toward the capacitor line 3b side. The connecting wire 31a is electrically coupled with the capacitor electrode 31 which is placed over the capacitor line 3b.

The capacitor electrode 31 is a square shape conductive part that is formed to overlap the capacitor line 3b when it is viewed in plan. The contact part 9b of the pixel electrode 9 is placed over the capacitor electrode 31. The pixel contact hole 45 is situated at the position where the capacitor electrode 31 and the contact part 9b overlap each other. The capacitor electrode 31 is electrically coupled to the pixel electrode 9 through the pixel contact hole 45. The capacitor electrode 31 opposes the capacitor line 3b in the thickness direction and forms the storage capacitor 70 whose electrodes are the capacitor electrode 31 and the capacitor line 3b.

In the sub-pixel region shown in FIG. 12, the color filter 22 that has substantially the same planar shape as the sub-pixel region and the reflective polarizing layer 19 that occupies about the half planar area of the sub-pixel region in the capacitor line 3b side are provided. The reflective polarizing layer 19 is the polarizing element according to the invention and which includes the polarizing element member made of a light-reflective metal film having a fine slit structure. The reflective polarizing layer 19 and the color filter 22 are formed on the opposing substrate 20. In the area where the strip electrode parts 9c and 39c are arranged alternatively as shown in FIG. 12, the forming region of the reflective polarizing layer 19 is the reflective display region R and the rest of the region is the transmissive display region T in the sub-pixel region.

Looking at the sectional structure along the line D-D′ which is shown in FIG. 13A, the liquid crystal layer 50 is held between the TFT array substrate 10 and the opposing substrate 20 which are placed so as to oppose each other. The polarizing plates 14, 24 are provided respectively on the outer side face (the face opposite to the liquid crystal layer 50) of the TFT array substrate 10 and the opposing substrate 20.

The TFT array substrate 10 has the light transmissive substrate body 10A which is made of glass, quartz, plastic or the like as a main body. The scan line 3a and the capacitor line 3b are formed on the inner face (the face closer to the liquid crystal layer 50) of the substrate body 10A. The gate insulating film 11 which is made of a transparent insulating film such as silicon oxide is formed so as to cover the scan line 3a and the capacitor line 3b.

The semiconductor layer 35 made of amorphous silicon is formed on the gate insulating film 11 which is situated on the scan line 3a. The source electrode 6b and the drain electrode 32 are formed such that a part of them is situated on the semiconductor layer 35. The drain electrode 32 is formed such that drain electrode 32, the connecting wire 31a and the capacitor electrode 31 form a single body. The semiconductor layer 35 is situated so as to oppose the scan line 3a with the gate insulating film 11 interposed therebetween. The part of the scan line 3a opposing the semiconductor layer 35 serves as the gate electrode of the TFT 30.

The capacitor electrode 31 is placed so as to oppose the capacitor line 3b with the gate insulating film 11 interposed therebetween. The storage capacitor 70 whose dielectric film is the gate insulating film 11 and whose electrodes are the capacitor electrode 31 and the capacitor line 3b is formed in the area where the capacitor electrode 31 opposes the capacitor line 3b

The inter-layer insulating film 12 made of silicon oxide or the like is formed so as to cover the semiconductor layer 35, the source electrode 6b, the drain electrode 32 and the capacitor electrode 31. The pixel electrode 9 and the common electrode 39 that are made of a transparent conductive material such as ITO are formed on the inter-layer insulating film 12. The pixel contact hole 45 that penetrates the inter-layer insulating film 12 and reaches to the capacitor electrode 31 is provided. The pixel electrode 9 is electrically coupled to the capacitor electrode 31 through a part of the contact part 9b of the pixel electrode 9 which fills the pixel contact hole 45. The alignment film 18 (horizontal alignment film) made of polyimide or the like is formed so as to cover the pixel electrode 9 and the common electrode 39.

Looking at the sectional structure along the line F-F′ which is shown in FIG. 13B, the strip electrode part 9a of the pixel electrode 9 and the strip electrode part 39a of the common electrode 39 are alternatively arranged in the same layer on the inter-layer insulating film 12. A horizontal electric field of the X-axis direction in FIG. 12 is generated between the strip electrode part 9a and the strip electrode part 39a by the voltage which is written into the pixel electrode 9 through the TFT. The alignment of the liquid crystal molecules in the liquid crystal layer 50 can be controlled by controlling the horizontal electric field.

Referring to FIG. 13A, the reflective polarizing layer 19 that includes the polarizing element member 112 and the coating film 117 formed in layers is partially formed on the liquid crystal layer 50 side face (the inner face) of the substrate body 20A which is the base body of the opposing substrate 20. The color filter 22 is provided all over the reflective polarizing layer 19 in the sub-pixel region. The alignment film 28 (horizontal alignment film) is formed on the color filter 22. As described above, the forming area of the reflective polarizing layer 19 is the reflective display region R and the area where the reflective polarizing layer 19 is not formed is the transmissive display region T.

It is also preferable in this embodiment that the color filter 22 be divided into two regions having different chromaticity in the pixel region. In this way, the color difference in the display light between the transmissive display region T and the reflective display region R can be prevented and it is possible to eliminate the difference in vision between the reflective display and the transmissive display and the display quality can be improved.

An insulating film made of a transparent resin material or the like may be further formed on the color filter 22. The color filter 22 is formed so as to cover the reflective polarizing layer 19 thereby the strain or distortion in the electric field caused by the polarizing element member 112 which is the metal film such as aluminum can be prevented with the color filter 22. However, this prevention effect can be enhanced when the above-mentioned insulating film is further formed.

The liquid crystal device 400 having such structure is the IPS type liquid crystal device. When an image signal (voltage) is applied to the pixel electrode 9 through the TFT 30, an electric field whose direction is the substrate face direction (the X-axis direction in FIG. 12) is generated between the pixel electrode 9 and the common electrode 39. The electric field drives the liquid crystal and an image can be displayed by changing the transmittance/the reflection rate in each sub-pixel. The alignment films 18 and 28 that oppose each other with the liquid crystal layer 50 interposed therebetween in the liquid crystal device 400 are processed with rubbing in the same direction when they are viewed in plan. The liquid crystal molecules forming the liquid crystal layer 50 horizontally align along the rubbing direction between the substrates 10 and 20 when a voltage is not applied to the pixel electrode 9. If the electric filed that is formed between the pixel electrode 9 and the common electrode 39 works in the crystal layer 50, the liquid crystal molecules realign in the width direction of the strip electrode parts 9c, 39c (the X-axis direction) shown in FIG. 12. The liquid crystal device 400 utilizes the birefringence caused by the difference in the alignment state of the liquid crystal molecules in order to perform a contrast display.

In the same way as the above-described embodiment, the liquid crystal device 400 also has the reflective polarizing layer 19 corresponding to the reflective display region. Therefore a fine contrast can be obtained both in the transmissive display and the reflective display without using a multi-gap structure Furthermore, the reflective polarizing layer 19 is the wire grid type polarizing element according to the invention in which the polarizing element member 112 is covered with the coating film 117. Therefore it is possible to prevent the pixel electrode 9 formed on the reflective polarizing layer 19 from entering into the openings in the polarizing element member 112. This prevents the optical characteristics of the reflective polarizing layer 19 from being worsen. Consequently, fine optical characteristics both in the transmissivity and the contrast (polarization selectivity) can be obtained at the reflective polarizing layer 19. In this way, it is possible to acquire a high contrast reflective display.

Moreover, the coating film 117 has the flat and smooth surface as shown in FIG. 6A so that the surface of the color filter 22 and the alignment film 18 which are formed on the coating film 117 can also be made flat and smooth. Thereby it is possible to precisely control the thickness of the liquid crystal layer. This helps to improve the display quality.

Furthermore, in the liquid crystal device 400 according to the embodiment, the thickness of the liquid crystal layer is constant between the transmissive display region T which is the main display part and the area where the display is performed by using the reflective polarizing layer 19 in the reflective display region R. Therefore, there will be no difference in the driving voltage in these regions and the display state will not differ between the reflective display and the transmissive display.

Furthermore, since the pixel electrode 9 and the common electrode 39 are made of the transparent conductive material, the outside light beam that goes through the liquid crystal layer 50 and then entered into the TFT array substrate 10 will not be reflected diffusely by the pixel electrode 9 and the common electrode 39. Consequently, it is possible to obtain a fine visibility.

### Fifth Embodiment

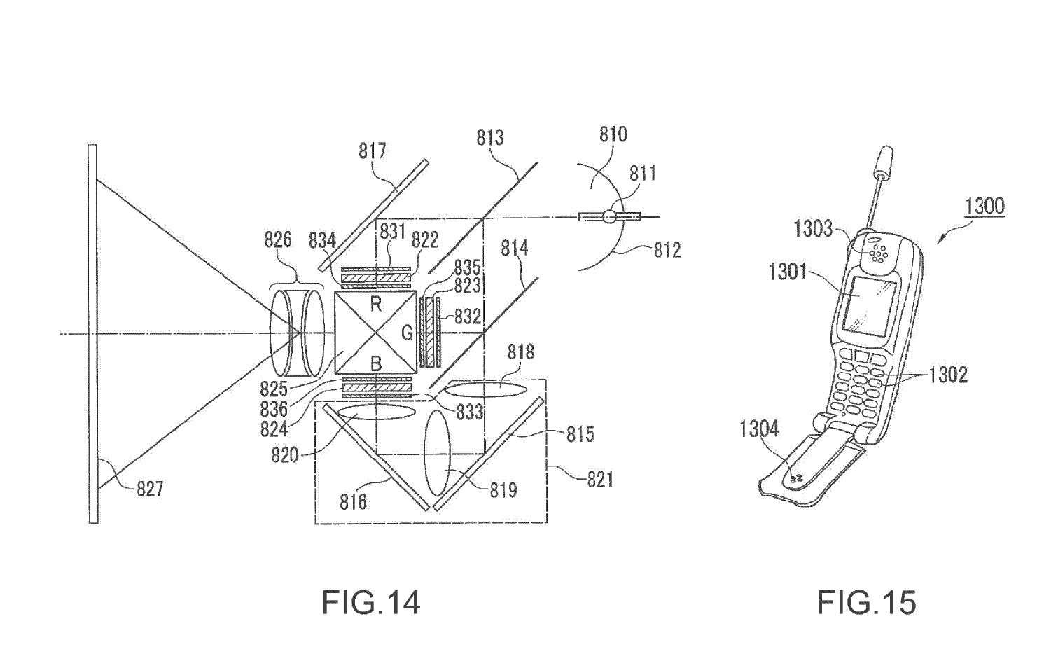

FIG. 14 is a schematic configuration diagram of a projector having the polarizing element according to the invention showing its key structures. The projector in this embodiment is a liquid crystal projector that has a liquid crystal device as an optical modulation device.

Referring to FIG. 14, the reference number 810 denotes a light source, 813, 814 are dichroic mirrors, 815, 816, 817 are reflective mirrors, 818 is an incident lens, 819 is a relay lens, 820 is an output lens, 822, 823, 824 are optical modulation devices having a liquid crystal device, 825 is a cross dichroic prism, 826 is a projection lens, 831, 832, 833 are polarizing elements on the incident side, and 834, 835, 836 are polarizing elements on the output side.

The light source 810 includes a lamp 811 such as a metal halide lamp and a reflector 812 that reflects light from the lamp. As for the light source 810, an ultrahigh pressure mercury lamp, a flash mercury lamp, a high pressure mercury lamp, a deep UV lamp, a xenon lamp, a xenon flash lamp or the like can be used in addition to the metal halide.

The dichroic mirror 813 transmits a red light component in a white light beam emitted from the light source 810 and reflects blue and green light components. The transmitted red light component is reflected by the reflective mirror 817 and enters into the red light liquid crystal optical modulation device 822 through the polarizing element 831. The green light component which is reflected by the dichroic mirror 813 is reflected by the dichroic mirror 814 and enters into the green light liquid crystal optical modulation device 823 through the polarizing element 832. The blue light component which is reflected by the dichroic mirror 813 is transmitted through the dichroic mirror 814. In order to prevent light loss through a long light path, a light guide system 821 is provided for the blue light. The light guide system 821 includes a relay lens system having the incident lens 818, the relay lens 819 and the output lens 820. Through the light guide system 821, the blue light component enters in the blue light liquid crystal optical modulation device 824 through the polarizing element 833.

The three colored light components which have been modulated respectively by the optical modulation devices 822-824 enter into the cross dichroic prism 825 through the corresponding polarizing elements 834-836. The cross dichroic prism 825 is made by adhering four rectangular prisms. On the interfaces of the cross dichroic prism 825, a dielectric multi-layered film that reflects the red light component and a dielectric multi-layered film that reflects the blue light component are formed so as to be arranged in X-shape. The three color components are synthesized by the dielectric multi-layered films and a light beam of a colored image is formed. The synthesized light beam is projected to a screen 827 through the projection lens 826 which is a projection optical system. The image displayed on the screen is enlarged.

In the projector according to the embodiment, the polarizing element according to the invention is used for the polarizing elements 831-836. In other words, as shown in FIG. 1, the polarizing element which includes the polarizing element member 112 that is made of the metal film 112M formed on the substrate and the coating film 117 covering the polarizing element member 112, and in which the openings 113 among the metal films 112M are made hollow spaces is adopted. The light source 810 having the metal halide lamp 811 emits a high energy light. Therefore if the polarizing element is made of an organic material, it can be degraded or deformed by the high energy light. For this reason, the polarizing element here has the polarizing element member 112 which is made of a highly light-resistant and heat-resistant metal film. Such polarizing element is used for the polarizing elements 831-836.

In the polarizing element according to the invention, the coating film 117 is formed on the face of the polarizing element member 112, on the face which is opposite to the substrate. The coating film 117 can protect the polarizing element member 112 that has the fine strip-formed metal films. Accordingly, the polarizing element according to the invention is highly reliable and easy to handle even in the electronic apparatus that has the polarizing element itself like the projector in this embodiment.

The polarizing elements 834-836 are separately provided from the optical modulation devices 822-824 in the embodiment. However, the polarizing element according to the invention can be formed directly on the substrate so that the polarizing element may be formed on the outer face (the face opposite to the liquid crystal) of the substrate of the liquid crystal panel which is the optical modulation device. The polarizing element member 112 that is formed on the outer face of the substrate can also be well protected by the coating film 117 thereby it is possible to make the optical modulation device highly reliable.

Electronic Apparatus

FIG. 15 is a perspective view of a cellar phone which is an example of the electronic apparatus having the liquid crystal device is used as a display part. A cellar phone 1300 includes a small size display part 1301 which is the liquid crystal device of the above-described embodiment, a plurality of manual operation buttons 1302, an ear piece 1303 and a mouth piece 1304.

The liquid crystal device of the above-described embodiment can also be adopted as an image display of an electronic book, a personal computer, a digital still camera, a liquid crystal television, a view finder type or direct view type video tape recorder, a car navigation device, a pager, an electronic databook, a calculator, a word processor, a work station, a videophone, a point-of-sale (POS) terminal, equipments having a touch panel and the like, in addition to the cellar phone. Any of the electronic apparatus having the polarizing element can obtain the transmissive display and the reflective display with a high brightness, a high contrast and a wide view angle.

What is claimed is:

1. A polarizing element, comprising:
a polarizing element member formed on a substrate and composed of a metal film that has a slit-shaped opening, the opening being provided in a plural number;
a coating film formed on the polarizing element member; and
a space surrounded by the coating film, the substrate and the metal film.

2. A polarizing element, comprising:
a polarizing element member formed on a substrate and composed of a metal film that has a slit-shaped opening, the opening is provided in a plural number;
a coating film formed on the polarizing element member; and
an air layer formed in the opening.

3. The polarizing element according to claim 1, wherein an open end of the opening is closed by a part of the coating film which is an aggregation of crystal grains that grow from an upper face of the metal film toward a direction opposite to the metal film.

4. The polarizing element according to claim 1, further comprising a seed layer containing a constituent element of the coating film and formed on an upper face of the metal film, wherein the coating film is an aggregation of crystal grains that grow from the seed layer.

5. The polarizing element according to claim 4, wherein the seed layer is selectively formed only on the upper face of the metal film.

6. The polarizing element according to claim 4, wherein the seed layer and the coating film are made of silicon oxide.

7. A method for manufacturing a polarizing element, comprising:
a) forming a metal film on a substrate;
b) forming a seed layer on the metal film;
c) forming an etching mask on the seed layer by patterning;
d) forming a slit-shaped opening in the metal film by removing the seed layer and the metal film partially through an etching process that uses the etching mask; and
f) forming a coating film that contains a constituent element of the seed layer on the metal film and the seed layer after the etching process.

8. The method for manufacturing a polarizing element according to claim 7, wherein in the step d), the etching process is dry-etching, and the seed layer and the metal film that are exposed in an opening area of the etching mask are simultaneously removed through the etching process.

9. The method for manufacturing a polarizing element according to claim 7, wherein in the step f), crystal grains are grown on the metal film from the seed layer, and the crystal grains close the slit-shaped opening.

10. The method for manufacturing a polarizing element according to claim 7, wherein silicon oxide films are formed as the seed layer and the coating film.

11. A liquid crystal device, comprising the polarizing element according to claim 1.

12. The liquid crystal device according to claim 11, wherein a liquid crystal layer is provided between a pair of substrates, the polarizing element is formed on a face of at least one of the pair of the substrates and the face is on a side of the liquid crystal layer.

13. The liquid crystal device according to claim 11, the liquid crystal device is a transflective type liquid crystal device in which both a transmissive display and a reflective display are possible in a single pixel, and wherein the polarizing element is provided as a reflective layer for the reflective display.

14. An electronic apparatus comprising the liquid crystal device according to claim 11.

15. An electronic apparatus comprising the polarizing element according to claim 1.
